(19) United States
(12) Patent Application Publication
(10) Pub. No.: US 2009/0009898 A1
(43) Pub. Date: Jan. 8, 2009

(54) Compliant Border for Thin Film Reflectors

(76) Inventors: William Clayton, Huntsville, AL (US); James Moore, Madison, AL (US); Gregory Laue, Huntsville, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/754,741

(22) Filed: May 29, 2007

(51) Int. Cl. G02B 7/182

(52) U.S. Cl. 359/871

(57) ABSTRACT

A thin film reflector with a compliant border has been developed. The thin film reflector includes a reflective membrane and a support apparatus that applies a tensile force to the reflective membrane. A compliant border region is located between the reflective membrane and the support apparatus to distribute the tensile forces applied by the support apparatus evenly across the reflective membrane.

### BACKGROUND OF INVENTION

1. Field of the Invention

The invention relates generally to thin film reflectors. More specifically, the invention relates to a compliant border for thin film reflectors.

2. Background Art

Thin planar membranes are typically thin polymer films with, a reflective metal coating. These membranes are used in space flight and orbital applications to reflect or concentrate solar energy. A reflective membrane may be used to protect orbital structures and equipment such as satellites from direct exposure to solar radiant flux. Alternatively, a reflective membrane may be used to concentrate solar energy on equipment such as a solar panel that powers a satellite.

When reflective membranes are deployed, they are typically held in place by application of a tensile or “stretching” force that is applied by attaching cables to the comers of the membrane. FIG. 1 shows an example of a prior art corner support 10 In this example, tire four corners of the rectangular shaped membrane 12 are attached to support cables 14. A tensile force 16 is applied to each cable 14 and the membrane 12 extends and holds its shape. The cables attempt to uniformly distribute the load across the membrane. In order to avoid wrinkles, the shape and elastic properties of the membrane must be precisely matched with the shape and elastic properties of the cables. Without a precise match, the membrane develops inherent wrinkles 18 called “Poisson wrinkles” on its surface. These wrinkles 18 have a negative impact on the reflective performance of the membrane. FIG. 2 shows another example of a prior art border support 20. In this example, the membrane 22 is held in place with catenary-shaped support cables 24. As with the previous example, a tensile force 26 is applied to each support cable 24 to hold the shape of the membrane. Poisson wrinkles 28 are also inherent in the membrane of this example.

In order to minimized the presence of wrinkles, the shape and elastic properties of the cables must be precisely matched to the shape and properties of the membrane. However, the precise matching is difficult. Consequently, a compliant border of a reflective thin film membrane that reduces the presence of wrinkles is needed.

### SUMMARY OF INVENTION

In some aspects, the invention relates to a thin film reflector, comprising: a reflective membrane; a support apparatus that applies a tensile force to the reflective membrane; and a compliant border between the reflective membrane and the support apparatus.

In other aspects, the invention relates to a thin film reflector, comprising: a reflective membrane; a support apparatus that applies a tensile force to the reflective membrane; and means for reducing wrinkles in the reflective membrane by utilizing a compliant border between the reflective membrane and the support apparatus,

In other aspects, the invention relates to a thin planar membrane apparatus, comprising: a thin-film membrane; a support apparatus that applies a tensile force to the thin-flim membrane; and a compliant border between the thin-film membrane and the support apparatus.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a view of a prior art corner support for a reflective membrane.

FIG. 2 show a view of a prior art border support for a reflective membrane.

FIG. 3 shows a view of a compliant border support for a reflective membrane in accordance with one embodiment of the present invention.

FIGS. 4a-4c show detailed views of a compliant border support for a reflective membrane in accordance with one embodiment of the present invention.

FIGS. 5a-5c show detailed views of membranes of a compliant border support for a reflective membrane in accordance with one embodiment of the present invention.

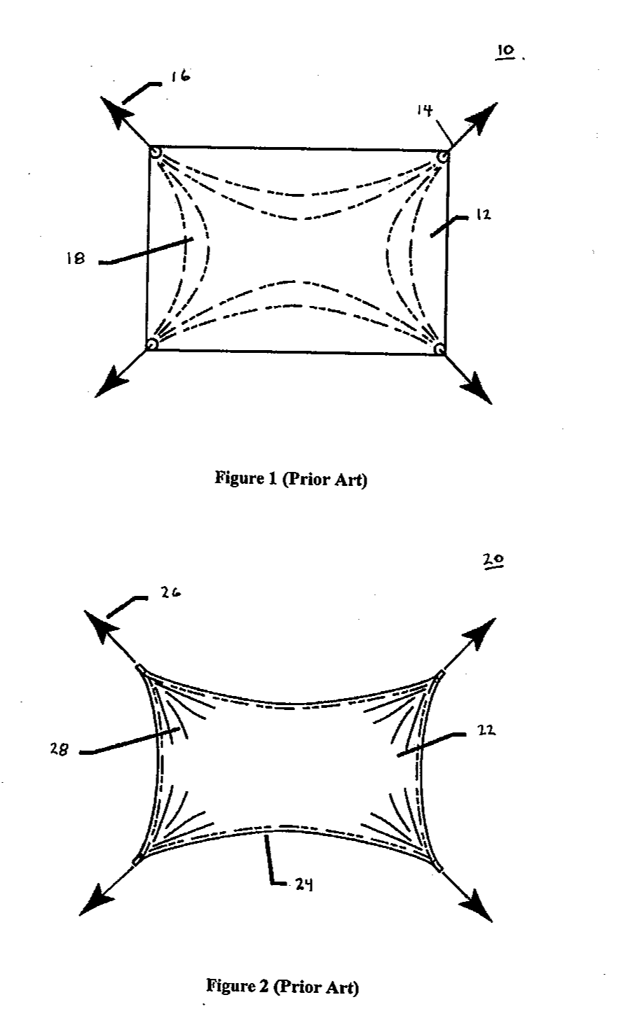

### DETAILED DESCRIPTION

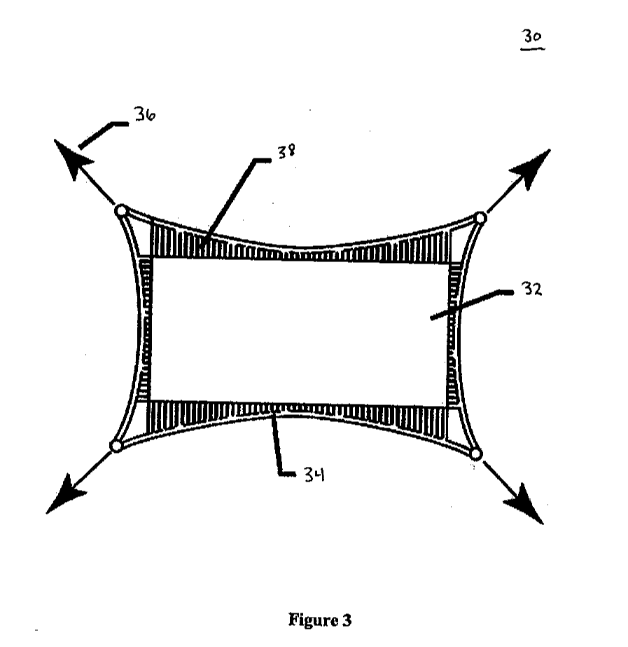

A compliant border for thin film reflectors has been developed. FIG. 3 shows an example of a compliant border support 30 for a reflective membrane. The membrane is typically of a light weight; thin polymer that is rendered reflective by coating it with, metallized evaporative coating. The membrane typically has a thickness of 1.0-127 microns. In this embodiment, the membrane 32 is supported by parabolic or circular shaped border cables 34 with an applied tensile force 36. A compliant interface 38 is located between the membrane 32 and the cables 34. The interface 38 greatly reduces to precision required match the shape and elastic properties of both the cables and the membrane. This has the effect of eliminating wrinkles on the membrane 32. The lack of Poisson wrinkles indicates a biaxial tensile stress in the membrane 32.

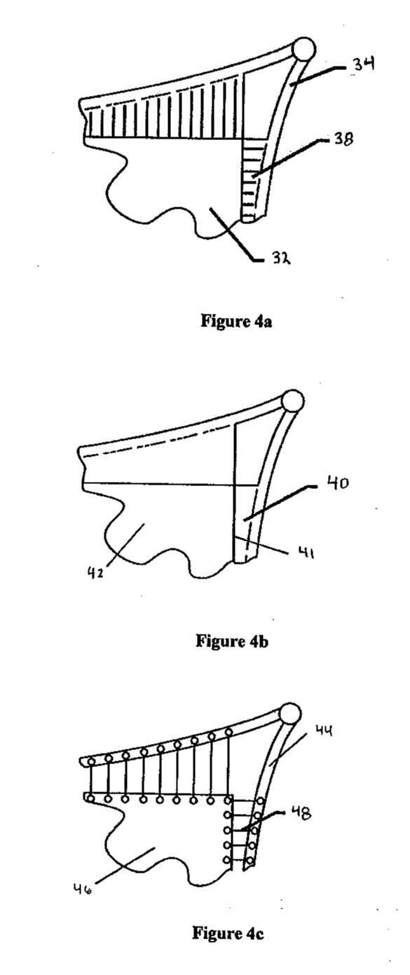

FIG. 4a shows a detailed view of the membrane 32, cable 34 and compliant interface 38 shown in FIG. 3, FIG. 4b shows an alternative embodiment of the present invention. In this example, the compliant interface 40 is a separate surface of an elastomer membrane or other elastic type material. This interface 40 is separated from the membrane 42 by a distinct edge 41. In this embodiment, the interface 40 absorbs and distributes the tensile forces applied by the cables so that Poisson wrinkles do not appear on the membrane 42. FIG. 4c shows another embodiment of the present invention. In this example, the cable 44 is isolated from the membrane 46 by a series of cords 48 running perpendicular to the membrane edge. The cords absorb and distribute the shear strain applied by the cables so that Poisson wrinkles do not appear on the membrane 46.

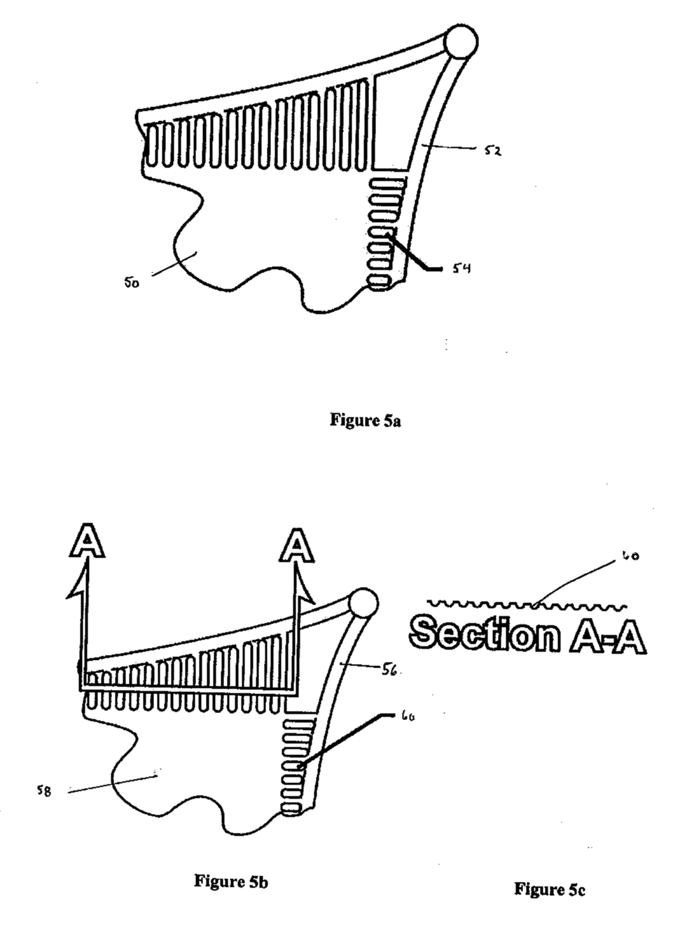

FIGS. 5a shows another embodiment of the present invention. In this example the cable 52 is isolated from the membrane 50 by a compliant interface 54 of slits in a membrane surface. The slits are oriented perpendicular to the edge of the membrane 50. The slits absorb and distribute the tensile forces applied by the cables so that Poisson wrinkles do not appear on the membrane 46.

FIGS. 5b and 5c show another embodiment of the present invention. In this example the cable 56 is isolated from the membrane 58 by a compliant interface 60 of indentions in a membrane surface. FIG. 5c shows a cross-sectional view of the compliant interface 60. The indentions are oriented perpendicular to the edge of the membrane. As with corresponding elements of other embodiments of the present invention, the indentions absorb and distribute the shear strain applied by the cables so that Poisson wrinkles do not appear on the membrane 58. The indentions of the interface are fanned in the membrane surface by a thermal forming process that uses the application of heat and a vacuum. The heated material of the membrane flows into a forming mandrel that forms the shape of the indentions.

While the previous examples have been used with a reflective membrane, it should be understood that the present invention may also be used with a non-reflective membrane. Non-reflective materials may include both clear and opaque materials. For example these materials could be a protective film that is used to protective the underlying surface from thermal exposure. The use of a compliant border serves to more evenly distribute the stress load across the membrane and consequently lengthen its life span.

In some other embodiments the reflective membrane could be used to reflect or concentrate solar radiant flux. The membrane could be used on satellites, solar sails, or other space applications. Additionally, other mechanisms besides cables could be used to apply the tensile force to the membrane such as fixed points or a support frame. While the invention has been described with respect to a limited number of embodiments, those skilled in the art, having benefit of this disclosure, will appreciate that other embodiments can be devised which, do not depart from the scope of the invention as disclosed here. Accordingly, the scope of the invention should be limited only by the attached claims.

What is claimed is:

1. A thin film reflector, comprising:
a reflective membrane;
a support apparatus that applies a tensile force to the reflective membrane; and
a compliant border between the reflective membrane and the support apparatus.

2. The thin film reflector of claim 1, where the support apparatus comprises a plurality of cables.

3. The thin film reflector of claim 2, where the cables are parabolic shaped.

4. The thin film reflector of claim 2, where the cables are circular shaped.

5. The thin film reflector of claim 1, where the compliant border comprises an elastic material.

6. The thin film reflector of claim 5, where the elastic material is an elastomer membrane.

7. The thin film reflector of claim 1, where the compliant border comprises a plurality of cords.

8. The thin film reflector of claim 7, where the cords are perpendicular to the edge of the reflective membrane.

9. The thin film reflector of claim 1, where the compliant border comprises a plurality of slits in the reflective membrane.

10. The thin film reflector of claim 9, where the slits are perpendicular to the edge of the reflective membrane.

11. The thin film reflector of claim 1, where the compliant border comprises a plurality of indentions in the reflective membrane.

12. The thin film reflector of claim. 11, where the indentions are perpendicular to the edge of the reflective membrane.

13. The thin film reflector of claim 1, where the reflective membrane concentrates solar radiant flux.

14. The thin film reflector of claim 1, where the reflective membrane reflects solar radiant flux.

15. A thin film reflector, comprising:
a reflective membrane;
a support apparatus that applies a tensile force to the reflective membrane; and
means for reducing wrinkles in the reflective membrane by utilizing a compliant border between the reflective membrane and the support apparatus.

16. A thin planar membrane apparatus, comprising:
a thin-film membrane;
a support apparatus that applies a tensile force to the thin-flim membrane; and
a compliant border between the thin-film membrane and the support apparatus.

17. The apparatus of Claim 1.6, where the thin-film membrane is clear.

18. The apparatus of Claim 1.6, where the thin-film membrane is opaque.
